(19) United States
(12) Patent Application Publication
(10) Pub. No.: US 2004/0216400 A1
(43) Pub. Date: Nov. 4, 2004

(54) Plate-like cover element for the opening of a building

(76) Inventor: Heinrich Salzer, Marburg (DE)

Correspondence Address: COLLARD & ROE, P.C., 1077 Northern Boulevard, Roslyn, NY, 11576-1696, US

(21) Appl. No.: 10/797,909

(22) Filed: Mar. 10, 2004

(30) Foreign Application Priority Data
Mar. 12, 2003 (DE) 203 04 020.1

(51) Int. Cl. E06B 1/04

(52) U.S. Cl. 52/204.1; 52/205

(57) ABSTRACT

A plate-like cover element for the opening of a building comprises two mutually opposite visible sides which are each provided with a plurality of glass fields (G). The glass fields are each delimited by regions (10, 11) made of a metallic material. Regions (10, 11) consisting of metallic material which delimit a plurality of glass fields (G) are formed on both visible sides by a sheet-metal plate (Bv, Bh) each in which the cut-outs (A) delimiting the glass fields (G) are incorporated by means of a cutting method and between which a glass pane (15) is arranged which extends substantially over the entire surface of the sheet-metal plate (Bv, Bh) prior to the incorporation of the cut-outs (A). The glass fields (G) each have a size which prevents the penetration by persons. The glass pane (15) and the sheet-metal plate (Bv, Bh) are arranged within frame elements enclosing the cover element in circular fashion. In order to also achieve a suitability for use in security-relevant areas such as prisons, forensic clinics, etct., it is proposed that a sheet-metal plate (Bh) is welded in an edge region (R) to a frame element.

The invention relates to a plate-like cover element for the opening of a building, comprising two mutually opposite visible sides which are each provided with a plurality of glass fields which are each delimited by regions made of a metallic material, with a plate-like cover element for the opening of a building, with two mutually opposite visible sides, which are each provided with a plurality of glass fields which are each delimited by regions consisting of metallic material which delimit a plurality of glass fields being formed on both visible sides by a sheet-metal plate each in which the cut-outs delimiting the glass fields are incorporated by means of a cutting method and between which a glass pane is arranged which extends substantially over the entire surface of the sheet-metal plate prior to the incorporation of the cut-outs, with the glass fields each having a size which prevents the penetration by persons, with the glass pane and the sheet-metal plate being arranged within frame elements enclosing the cover element in circular fashion. Such a cover element has been described in the priority-establishing German utility model application DE 203 04 020.1 whose entire scope of disclosure is also included in the content of the present application by way of reference.

Such cover elements are known from the older specifications such as DE 200 03 914 U1, DE 202 12 489 U1, DE 298 23 157 U1 and DE 93 10 235 U1. All these described cover elements are predominantly concerned with merely the decorative aspect which can be achieved by means of cut sheet-metal plates or cover plates made of other materials and possibly commercial aspects (minimization of production costs). The idea to use such cover elements in locations where security aspects play a decisive role, i.e. in prisons, forensic clinics, etc., has not yet been put forward.

Plate-like cover elements are frequently used in the form of doors, windows or even fixed elements in prisons, forensic clinics or similar institutions. Whereas the glass fields should provide the best possible unobstructed visible view from one side to the other side of the cover element, the comparatively large number of glass fields is usually chosen for the reason to keep the dimensions of the individual glass fields as small as possible. It must be ensured in prisons or forensic clinics that even in the event of destruction of an individual glass element the passage of persons through the originating openings is prevented. To ensure that the regions consisting of metallic material between adjacent glass fields offer the required resistance against passing, these regions are usually configured as massive or hollow-profile-like staves which are mostly rigidly connected with the other frame elements.

Especially when the number of glass fields is high in a cover element, the efforts for producing such a cover element are also very high. The incorporation of the staves and their joining with the frame construction is laborious and it is very time-consuming and cumbersome to provide the individual openings with comparatively small glass panes. Every single glass pane must be fixed with respective seals and cover strips for the glass. When taking into account that the height of a glass field must not typically exceed an amount of approximately 120 mm in order to prevent the passage of a person through any arising opening of this size, a door of regular format with a surface area of approximately 2 m² will have not less than 6 to 10 glass fields situated above one another. The considerable production and mounting efforts required for such a cover element is clearly to be seen.

The invention is based on the object of further developing a plate-like cover element for the opening of a building in such a way that even in the case of a large number of glass fields the efforts required for the production and mounting are kept low. At the same time, the door should also meet the high requirements placed on preventing breaking in and breaking out. In particular, at least one sheet-metal plate should not easily be dismountable or removable and, if desired, it should also meet certain requirements concerning resistance to bombardment with projectiles or blast effects as well as fire protection.

Based on the cover element of the kind mentioned above, this object is achieved in accordance with the invention in such a way that a sheet-metal plate is welded in an edge region to a frame element.

The invention is based on the finding that for the production of the holding construction for the glass panes in the present special application it is not advisable to use strut- or stave-like construction elements which may optionally be combined with other frame elements. Instead, production efforts and costs can also be minimized in such a way that plate-like starting material in the form of sheet-metal plates is used into which the openings are incorporated which will later delimit the glass fields, depending on the desired dimensions. In this process, a cutting method, and preferably a laser cutting method, but also alternatively a punching, jet cutting or flame cutting method are used. The desired cut-outs can be produced especially with the help of laser cutting methods with very short processing periods and outstanding surface qualities that do not even require metal-cutting finishing work to the cutting edges. The fact that in comparison with a strut or stave construction a far from inconsiderable amount of the sheet-metal material is obtained as waste is fully acceptable for economic reasons due to the considerably reduced production times. Moreover, the sheet-metal material obtained as waste can easily be supplied to recycling processes which are already very well organized in respect of metallic materials.

The formation of the cover element proceeds in such a way that two preferably identical sheet-metal plates with congruent cut-outs are arranged on either side of a central glass pane which thus covers all cut-outs in the sheet-metal plates and substantially corresponds with respect to its outside diameters to those of the sheet-metal plate. It is thus no longer necessary in the cover element in accordance with the invention to provide every single section with a separate glass plane. Instead, the glass plane forming several or all glass fields also extends into the regions between adjacent glass fields, from the outside through the two sheet-metal plates but covered in an invisible way. The construction in accordance with the invention is thus not only characterized by a low amount of effort in the production of a “frame construction” within the terms of a sheet-metal plate with cut-outs, but also by an especially simple glazing of this “frame construction” with the help of usually only one single glass pane.

In accordance with the invention, the cover element can thus also not be penetrated by persons when a sheet-metal plate which is fixed with visibly screwed glass holding strips is also removed after its dismounting like the glass pane. As a result of the welding of the other sheet-metal plate with at least one frame element, the sheet-metal plate can hardly be removed and the cut-outs contained in the same do not allow any person to pass through the cover element due to its size. The welding of a sheet-metal plate with associated frame elements further constitutes a very inexpensive possibility to provide a joining.

Based on a cover element of the kind described above, an alternative solution in accordance with the invention is that a sheet-metal plate is welded together with the associated glass holding strips and the glass holding strips are screwed together with frame elements from one face side of the cover element which is merely accessible in the opened state of the cover element.

In a closed state of the cover element, which is usually the case in prisons or forensic clinics for example, there is neither a possibility for the persons within the room provided with the cover element nor for persons which may wish to undertake an effort to liberate someone within the room to remove the glass holding strip by using screwdrivers or similar simple tools.

In accordance with a further development of the invention, it is provided for in this connection that a sheet-metal plate facing a web of a frame element projects on the edge side beyond the glass pane and is welded together with a side surface of the frame element extending perpendicular to the visible side of the cover element. As an alternative to a direct welding connection between sheet-metal plate and frame it is also possible to provide a welding of the sheet-metal plate with holding strips which extend circularly over the edge side and which on their part are joined to the frame elements by means of screws.

According to a further alternative solution in accordance with the invention, the object is achieved on the basis of a cover element of the kind mentioned above in such a way that flat profiles which are aligned rectangularly to the plane of the sheet-metal plate are welded onto a sheet-metal plate, which flat profiles are fastened by means of screws to a side surface of a frame element, with the glass pane being glued together with the sheet-metal plate optionally via an intermediate layer and the glass pane covering the screws.

It can thus be achieved that even after the removal of a sheet-metal plate which is fixed by means of visibly screwed glass holding strips for example, the second sheet-metal plate cannot be removed easily despite the screwed connection of the same. As a result of the coverage of the screws by the glass pane, they are not accessible to tools such as screwdrivers for example. The coverage of the screws for fastening the second sheet-metal plate cannot be removed easily as a result of the gluing of the glass pane directly or indirectly with the second sheet-metal plate. Such an embodiment can make do entirely without any welded connections between the sheet-metal plates and the frame elements and therefore offers advantages especially in the case of repairs when the cover element needs to be repaired on site and without any cumbersome transport to a workshop.

According to a preferred embodiment, the glass pane is clamped between the sheet-metal plates and is thus fixed in its position. The gluing of the “sandwich” construction formed by the glass pane and the sheet-metal plate and possible intermediate layers can be used to increase the strength.

It is provided for according to a further embodiment of the invention that a sheet-metal plate rests on a web projecting in the cross section of the respective frame element.

It is further provided that a sealing profile is arranged between a sheet-metal plate and the web of the frame element, which profile produced a secure damping of any impact forces through its rubber-elastic properties.

A lateral displacement of sheet-metal plates and a glass pane relative to each other can be securely prevented in such a way that an intermediate layer made of cellular rubber is arranged between the glass pane and the sheet-metal plates, with the intermediate layers each having cut-outs congruent with respect to the cut-outs of the sheet-metal plate. The intermediate layer thus delimits the glass fields on the face side like the directly adjacent face sides of the sheet-metal plates in the region of the cut-outs. The rubber-elastic cellular-rubber intermediate layer further offers a very good possibility to compensate any tolerances in the multi-layer panel packet.

The invention is now explained in closer detail by reference to several embodiments which are shown in the drawings, wherein:

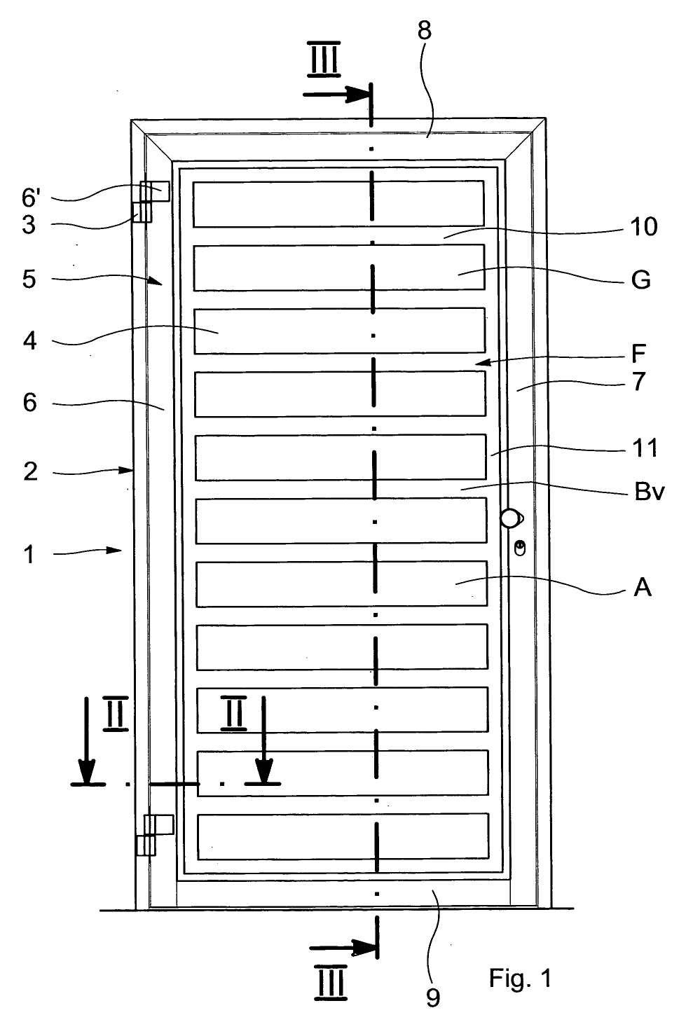

FIG. 1 shows a view of a plate-like cover element in the form of a door;

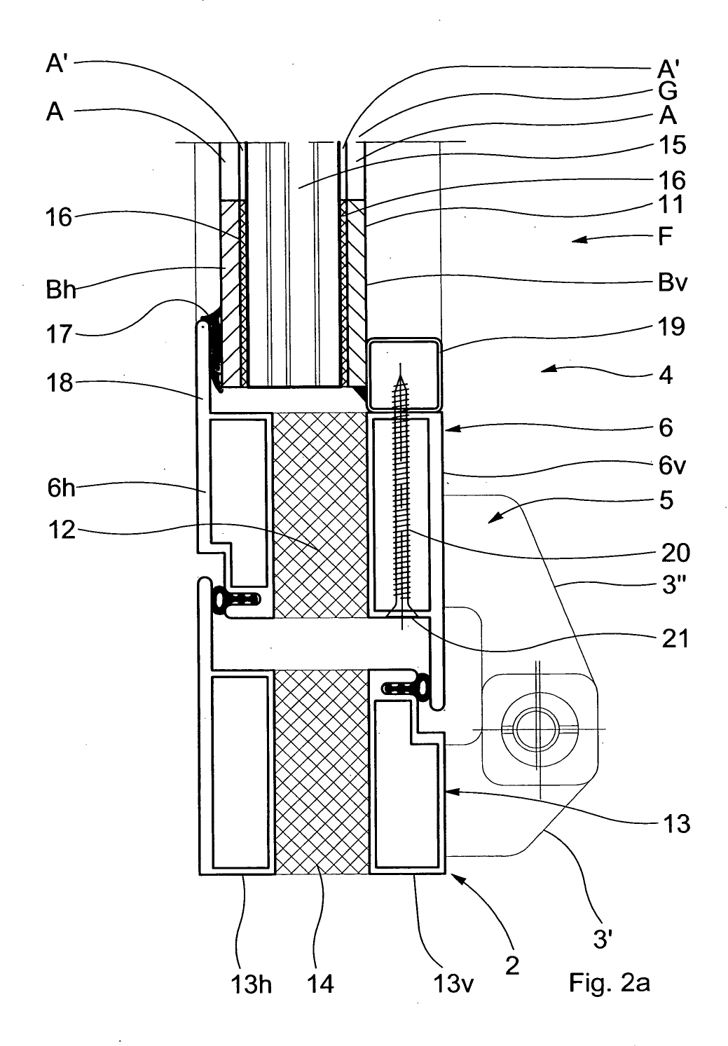

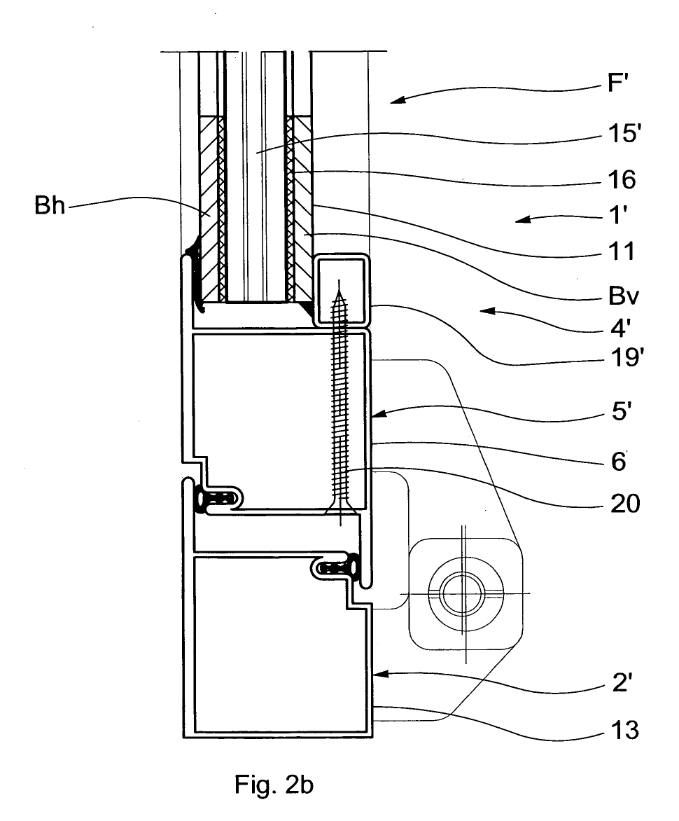

FIG. 2a shows a horizontal sectional view along the line II-II through the door according to FIG. 1;

FIG. 2b shows a view as in FIG. 2a, but with an alternative configuration of the frame profiles;

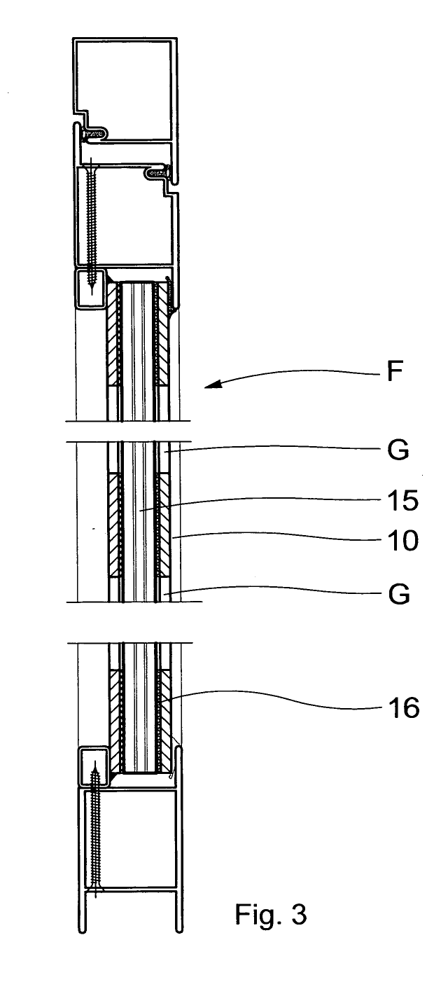

FIG. 3 shows a vertical sectional view along the line III-III through the door according to FIG. 1;

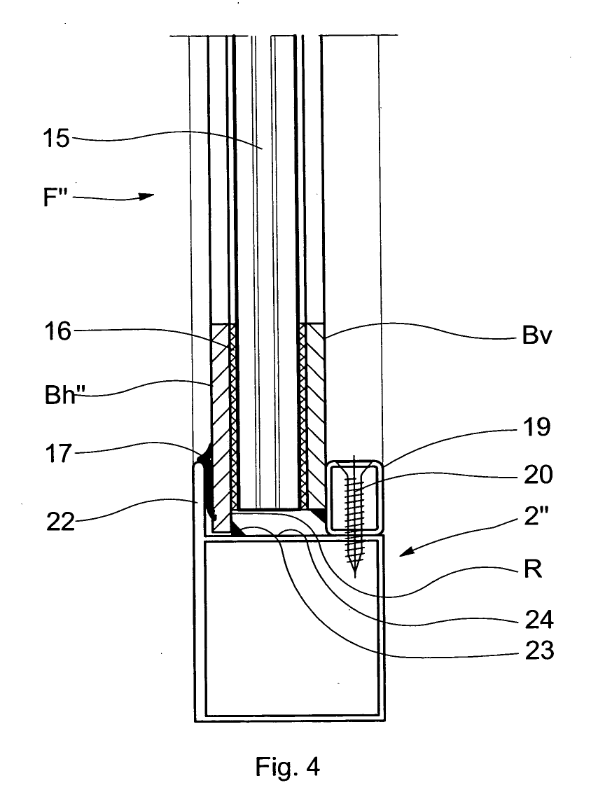

FIG. 4 shows a view as in FIG. 2a, but with an alternative method for fastening the panel and

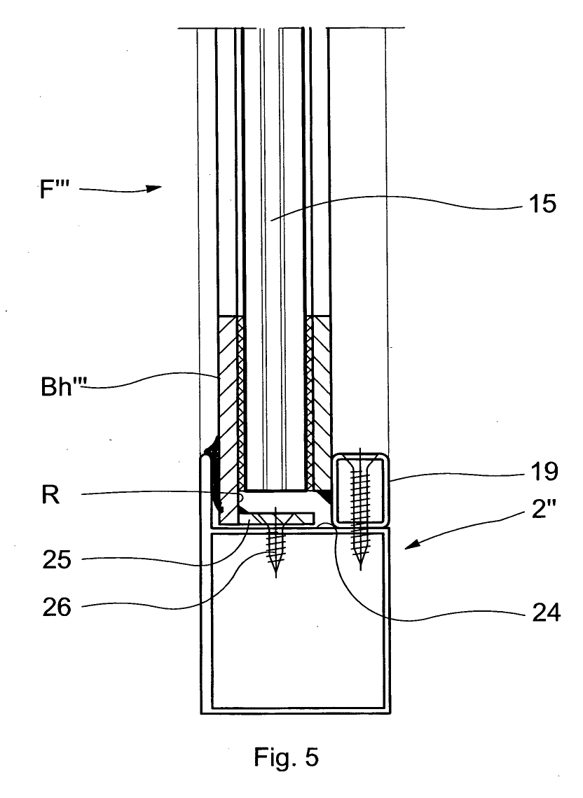

FIG. 5 shows a view as in FIG. 4, but with another alternative method for fastening the panel.

FIG. 1 shows a view of a door 1 which is fastened to a door frame 2 with the help of bands 3 on the door frame side. The door frame 2 is fastened in the conventional manner (not shown) to a reveal of the opening of a building which can be closed off by means of a plate-like door leaf which is held in a pivotable manner within the door frame 2. The door leaf 4 consists of the sash 5 to which the door-leaf-side bands 6′ are fastened. The sash 5 consists of two longer vertical frame legs 6 and 7 and two shorter horizontal frame legs 8 and 9.

Within the sash 5 of the door leaf 4 there is a panel 8 which consists of eleven glass fields G which are arranged in an equidistant manner relative to each other as well as regions 10 which are arranged in a stave-like manner and which consist of metallic material. The dimensions of the glass fields G are approximately 120 mm in the height and approximately 700 mm in the width. In the region of the glass fields G it is possible to see through the door leaf 4. On either side next to the row of glass fields G there is a vertically extending further region 11 made of metallic material which separates the glass fields G in the horizontal direction from the vertical frame legs 7.

Both the horizontal regions 10 as well as the vertical regions 11 made of metallic material are formed on the front and back side of the door 1 by a continuous sheet-metal plate Bv and Bh into which a respective number of cut-outs A were made for the glass fields G with the help of a cutting method. The thickness of the sheet-metal plates Bv and Bh should be chosen in such a way (also depending on the material used) that a bending of the region 10 is not possible even in the case of destruction or removal of the glass pane. In the present case the thickness of the sheet-metal plate Bv and Bh is 5 mm.

As can be seen in the horizontal sectional view according to FIG. 2a, the vertical frame leg 6 of the sash consists for reasons of thermal separation of a front profile element 6v and a rear profile element 6h which are mutually connected through an intermediate layer 12 made of insulating material. Similarly, the vertical frame leg 13 of the door frame 2 consists of a front profile element 13v and a rear profile element 13h which are also mutually connected through an insulating intermediate layer 14. Special requirements both with respect to thermal insulation as well as with respect to fire protection can be fulfilled with the help of the intermediate layer 14.

The panel F consists of a central continuous glass pane 15 made of multi-layer laminated glass which in the present case has a thickness of approximately 25 mm, an intermediate layer 16 made of cellular rubber arranged on either side and a sheet-metal plate Bv and Bh which is each adjacent thereto on the outside. Since a passage through the cut-outs A is not possible, the use of bullet-proof glass can usually be omitted. When special requirements are demanded in respect to fire protection, it is also possible to use a special glass pane 15 made of fire-resisting glass which contains material which foams up under the influence of heat. The intermediate layer 16 comprises cut-outs A′ which are arranged in a congruent manner relative to the cut-outs A in the sheet-metal plates Bv and Bh. As a result of the high static friction between the intermediate layer 16 consisting of cellular rubber and the sheet-metal plates Bv, Bh on the one hand and the glass pane 15 on the other hand, any slippage of the different layers of the panel F with respect to each other is prevented. The cellular-rubber intermediate layer can be self-adhesive on one side for example or be glued together with one of the sheet-metal plates Bv, Bh or the glass pane 15 by means of a separate adhesive.

The rear sheet-metal plate Bh rests via a sealing profile 17 on a web 18 of the rear frame leg 6h of the sash 5. At the opposite side of the panel F a frame made of tubes with a square cross section are welded to the front sheet-metal plate BV circularly around the edge side, which tube assumes the function of a glass holding strip 19. With the help of screws 20, said glass holding strip 19 is screwed together with the front frame leg 6v of the sash 5 and, in the regions not shown, also with the other vertical and the other horizontal frame legs 7v and 8v and 9v. The screw heads 21 are only accessible in the opened state of the door 1, namely when the door leaf 4 is wide open, so that in the closed state of the door 1 there is no possibility for manipulation, meaning that the panel F cannot be removed from the sash 5.

FIG. 2b shows an alternative door 1′ in which both the door frame 2′ as well as the sash 5′ of the door leaf 4′ are each formed by integral profile elements 6, 7, 8, 9 and 13. Whereas the glass pane 15′ of the panel F′ is merely 15 mm thick in this case, the layers of the intermediate layer 16 and the sheet-metal plates Bv and Bh are unchanged with respect to the embodiment as shown in FIG. 2a. The glass holding strip 19′ comprises a reduced width as compared with the glass holding strip 19 in FIG. 2a, so that the glass holding strip 19′ is flush with the front side of the door frame 5′. The fastening of the glass holding strip 19′ occurs in an analogous way by means of hidden screws 10, as in the case of the embodiment according to FIG. 2a.

The vertical section according to FIG. 3 shows that the glass pane 15 extends over the entire surface of the panel F, meaning that it is situated both (visibly) in the region of the glass fields G and (invisibly) in the region of the interposed stave- or web-like horizontal regions 10 between adjacent glass fields G, as also in the region of the vertical areas 11 of the sheet-metal plates Bv and Bh laterally adjacent to the glass fields G (see FIGS. 2a and 2b). The sheet-metal plates Bv and Bh thus form with their thickness of 5 mm for example a metallic grating structure which can be produced very quickly and inexpensively from respective slab material with the help of the laser cutting method. As a result of a simple stacking by using intermediate layers 15 which are also produced by a cutting method it is possible to produce a multi-field glazing without any major mounting efforts which meets high requirements both with respect to security against breaking in and breaking open and also offers security against explosive effects or penetration by projectiles. Especially when using frame profiles with certified properties it is possible to simply produce a door or any other cover element for the opening in a building which meets a large variety of requirements.

FIG. 4 further shows a horizontal sectional view through an alternative cover element in accordance with the invention in the form of a fixed element without any possibility for opening. The door frame 2″ comprises a web 22 which is used for supporting the panel F″ (which again occurs through a sealing profile 17). The structure of the panel F″ is also composed in this case of a central glass pane 15, intermediate layers 16 made of cellular rubber which are arranged on either side of the same as well as two sheet-metal plates Bv″ and Bh″, but it is not symmetric to the central plane of the glass pane 15 in this case. The rear sheet-metal plate Bh″ projects with its bordering strip R circularly beyond the front sheet-metal plate Bv, the intermediate layers 16 and the glass pane 15 and is connected in the region of said bordering strip R with the help of weld seam 23 with the side surfaces 24 of the associated frame leg of the door frame 2″. A non-detachable unit made of the profile elements of the door frame 2″ and the sheet-metal plate Bh″ which is provided with the cut-outs is created which under the condition of sufficiently small dimensions of the cut-out A cannot be penetrated by persons even if the layers of the panel F″ situated in front of the same have been removed. In the case of a fixed field, the fastening of the glass holding strips 19 to the associated door frame 2″ is not possible by only covered accessible screws as is realized in a cover element with an openable leaf. In the present case, the screws 20 for fastening the glass holding strip 19 are accessible from the outside and would have to be secured by special measures such as the beating in of steel balls into the screw heads or a boring of the same. In such a case the subsequent exchange of the glass pane 15 for example is only possible with a considerable amount of effort, so that the welding of the rear sheet-metal plate Bh″ with the door frame 2″ as shown in FIG. 4 is preferable.

FIG. 5 shows an alternative type of fastening for the panel F″′ of a fixed element. A circular frame made of flat profiles 25 which are aligned rectangularly to the plane of the sheet-metal plate Bh″′ is welded to the rear sheet-metal plate Bh″′. The unit formed by the sheet-metal plate Bh″′ and flat profiles 25 can be fastened on site to the side surfaces 24 of the door frame 2″ without welding with the help of screws 26 which are guided through bores in the flat profiles 25.

1. A plate-like cover element for the opening of a building, comprising two mutually opposite visible sides which are each provided with a plurality of glass fields (G) which are each delimited by regions (10, 11) made of a metallic material, with regions (10, 11) consisting of metallic material which delimit a plurality of glass fields (G) being formed on both visible sides by a sheet-metal plate (Bv, Bh, Bh″) each in which the cut-outs (A) delimiting the glass fields (G) are incorporated by means of a cutting method and between which a glass pane (15) is arranged which extends substantially over the entire surface of the sheet-metal plate (Bv, Bh, Bh″) prior to the incorporation of the cut-outs (A), with the glass fields each having a size which prevents the penetration by persons, with the glass pane (15) and the sheet-metal plate (Bv, Bh, Bh″) being arranged within frame elements enclosing the cover element in circular fashion, characterized in that a sheet-metal plate is welded in an edge region (R) to a frame element.

2. A plate-like cover element according to the preamble of claim 1, wherein a sheet-metal plate (Bv) is welded together with the associated glass holding strips (19) and the glass holding strips (19) are screwed together with frame elements from one face side of the cover element which is merely accessible in the opened state of the cover element.

3. A plate-like cover element according to claim 1, wherein a sheetmetal plate (Bh″) facing a web (22) of a frame leg projects on the edge side beyond the glass pane (15) and is welded together with a side surface (24) of the frame element extending perpendicular to the visible side of the cover element.

4. A plate-like cover element according to the preamble of claim 1, wherein flat profiles which are aligned rectangularly to the plane of the sheet-metal plate (Bh″′) are welded onto a sheet-metal plate (Bh″′), which flat profiles are fastened by means of screws (26) to a side surface (24) of a frame element, with the glass pane (15) being glued together with the sheet-metal plate (Bh″′), optionally via an intermediate layer (16), and with the glass pane (15) covering the screws (26).

5. A plate-like cover element according to claim 1, wherein the glass pane (15) is clamped between the sheet-metal plates (Bv, Bh, Bh″).

6. A plate-like cover element according to claim 1, wherein a sheet-metal plate (Bh, Bh″) rests on a web (18, 22) projecting in the cross section of the respective frame element.

7. A plate-like cover element according to claim 6, wherein a sealing profile (17) is arranged between a sheet-metal plate (Bh, Bh″) and the web (18, 22) of the frame element.

8. A plate-like cover element as claimed in claim 1, wherein an intermediate layer (16) made of cellular rubber is each arranged between the glass pane (15) and the sheet-metal plates (Bv, Bh, Bh″), with the intermediate layers each having cut-outs (A) congruent with respect to the cut-outs (A) of the sheetmetal plate (Bv, Bh, Bh″).
